(19) United States
(12) Patent Application Publication
(10) Pub. No.: US 2026/0356350 A1
(43) Pub. Date: Nov. 12, 2026

(54) VEHICLE CONTROL DEVICE, VEHICLE CONTROL METHOD, AND COMPUTER PROGRAM FOR VEHICLE CONTROL

(71) Applicant: TOYOTA JIDOSHA KABUSHIKI KAISHA, Toyota-shi (JP)

(72) Inventor: Kenta KUMAZAKI, Tokyo-to (JP)

(73) Assignee: TOYOTA JIDOSHA KABUSHIKI KAISHA, Toyota-shi (JP)

(21) Appl. No.: 19/645,768

(22) Filed: Apr. 13, 2026

(30) Foreign Application Priority Data
May 8, 2025 (JP) 2025-078119

(51) Int. Cl. B60W 30/045; B60W 40/072; G06V 10/764; G06V 10/774; G06V 20/56; G06V 10/82

(52) U.S. Cl. CPC B60W 30/045; B60W 40/072; G06V 10/764; G06V 10/774; G06V 20/588; B60W 2420/403; B60W 2552/20; B60W 2552/53; B60W 2720/10; G06V 10/82

(57) ABSTRACT

A vehicle control device includes a processor configured to: estimate a shape of a road section in which a vehicle will travel in the future based on an image which represents a periphery of the vehicle at every predetermined period, set a target trajectory of the vehicle based on the estimated shape each time the shape of the road section is estimated, calculate, for each point of the road section, a curvature of the point by averaging the curvature of the point calculated based on the shape estimated from each of a plurality of images obtained in a latest predetermined period, set a target speed when the vehicle travels in the road section according to the curvature of each point of the road section, and control the vehicle so that the vehicle travels along the target trajectory in the road section at the target speed.

### FIELD

The present invention relates to a vehicle control device, a vehicle control method, and a computer program for controlling a vehicle.

### BACKGROUND

A technique has been proposed in which a target trajectory is generated based on division line information represented in a space obtained by converting an image captured by a camera mounted on a moving body into a bird view coordinate system, and a speed plan indicating the target speed is generated based on the curvature of the target trajectory (see Japanese Unexamined Patent Publication No. 2023-82451).

### SUMMARY

By generating the target trajectory based on the division line detected from the image as described above, it is possible to set the target speed in the curve section without using a high-precision map in which the road shape is expressed with high accuracy. However, due to the detection accuracy of a feature such as a devision line and the effect of an obstacle existing on the road, the shape of the road on which the vehicle is traveling may not be accurately estimated from the image. In such a case, the behavior of the vehicle controlled based on the estimated road shape may become unstable.

It is an object of the present invention to provide a vehicle control device capable of preventing inappropriate vehicle control from being executed.

According to one embodiment, a vehicle control device is provided. The vehicle control device includes a processor configured to: estimate a shape of a road section in which a vehicle will travel in the future based on an image which represents a periphery of the vehicle and is generated by a camera mounted on the vehicle at every predetermined period, set a target trajectory of the vehicle based on the estimated shape each time the shape of the road section is estimated, calculate, for each point of the road section, a curvature of the point of the road section by averaging the curvature of the point calculated based on the shape of the road section estimated from each of a plurality of images obtained in a latest predetermined period, set a target speed when the vehicle travels in the road section according to the curvature of each point of the road section, and control the vehicle so that the vehicle travels along the target trajectory in the road section at the target speed.

In one embodiment, the processor is further configured to: detect a lane division line from the image, estimate the shape of the road section based on the detected lane division line, and set the predetermined period at a point at which the lane division line is not detected in the latest image among the individual points of the road section to be longer than the predetermined period at a point at which the lane division line is detected in the latest image.

In one embodiment, the processor is further configured to: detect the lane division line by inputting the image to a classifier trained in advance so as to detect the lane division line, and increase the predetermined period as the number of teacher images representing an environment around the vehicle when the vehicle travels in the road section among the plurality of teacher images used for training of the classifier decreases.

According to another embodiment, a vehicle control method is provided. The vehicle control method includes: estimating a shape of a road section in which a vehicle will travel in the future based on an image which represents a periphery of the vehicle and is generated by a camera mounted on the vehicle at every predetermined period; setting a target trajectory of the vehicle based on the estimated shape each time the shape of the road section is estimated; calculating, for each point of the road section, a curvature of the point of the road section by averaging the curvature of the point calculated based on the shape of the road section estimated from each of a plurality of images obtained in a latest predetermined period; setting a target speed when the vehicle travels in the road section according to the curvature of each point of the road section; and controlling the vehicle so that the vehicle travels along the target trajectory in the road section at the target speed..

According to still another embodiment, a non-transitory recording medium that stores a computer program for controlling a vehicle is provided. The computer program causes a processor mounted on the vehicle to execute the process including: estimating a shape of a road section in which a vehicle will travel in the future based on an image which represents a periphery of the vehicle and is generated by a camera mounted on the vehicle at every predetermined period; setting a target trajectory of the vehicle based on the estimated shape each time the shape of the road section is estimated; calculating, for each point of the road section, a curvature of the point of the road section by averaging the curvature of the point calculated based on the shape of the road section estimated from each of a plurality of images obtained in a latest predetermined period; setting a target speed when the vehicle travels in the road section according to the curvature of each point of the road section; and controlling the vehicle so that the vehicle travels along the target trajectory in the road section at the target speed.

The vehicle control device according to the present disclosure can prevent inappropriate vehicle control from being executed.

### BRIEF DESCRIPTION OF DRAWINGS

FIG. 1 schematically illustrates the configuration of a vehicle on which a vehicle control device is mounted.

FIG. 2 is a functional block diagram of a processor of an electronic control unit that is an embodiment of a vehicle control device.

FIG. 3 is a timing chart illustrating a temporal change in curvature and a target speed according to the present embodiment and a temporal change in curvature and a target speed according to a comparative example.

FIG. 4 is an operation flowchart of the vehicle control process.

### DESCRIPTION OF EMBODIMENTS

Hereinafter, a vehicle control device, a vehicle control method executed on the vehicle control device, and a computer program for vehicle control will be described with reference to the drawings. The vehicle control device estimates a shape of a road section in which a vehicle will travel in the future on the basis of an image which represents a situation around the vehicle and is generated by a camera mounted on the vehicle, and, each time the shape of the road section is estimated, sets a target trajectory of the vehicle based on the estimated shape. Further, the vehicle control device calculates, for each point of the road section, the curvature of the point by averaging the curvature of the point obtained based on the shape of the road section estimated from each of the plurality of images obtained in the latest predetermined period, and sets a target speed at which the vehicle travels in the road section in accordance with the curvature of each point of the road section. The vehicle control device controls the vehicle to cause the vehicle to travel along the target trajectory in the road section at the target speed. With such a configuration, the vehicle control device sets the target trajectory that does not deviate in the curve section without using a high-precision map including information on the shape of each road section, and suppresses a rapid fluctuation of the target speed in the curve section, thereby stabilizing the behavior of the vehicle.

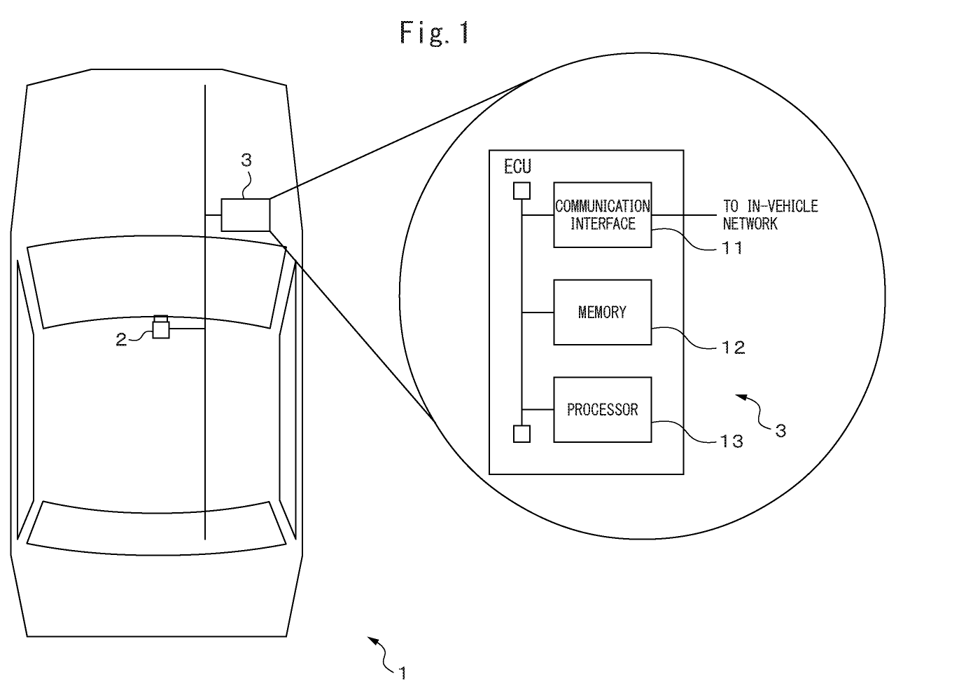

FIG. 1 schematically illustrates the configuration of a vehicle on which a vehicle control device is mounted. In the present embodiment, the vehicle 1 includes a camera 2 and an electronic control unit (ECU) 3, which is an example of the vehicle control device. The camera 2 and the ECU 3 are communicably connected to each other. Note that the vehicle 1 may further include a range sensor (not shown) that measures a distance to an object existing around the vehicle 1, such as a LiDAR or a radar. The vehicle 1 may further include a wireless communication terminal (not shown) for wirelessly communicating with an external device of the vehicle 1. Furthermore, the vehicle 1 may further include a positioning device (not shown) for measuring the position of the vehicle 1 according to a satellite-based positioning system, such as a GPS receiver.

The camera 2 is an example of an imaging unit, and is attached to the vehicle 1 toward a predetermined region around the vehicle 1 (for example, a front region of the vehicle 1) such that the predetermined region is included in an imaging range of the camera 2. Then, the camera 2 captures the predetermined region every predetermined capturing cycle (for example, 1/30 second to 1/10 second) and generates an image in which the predetermined region is represented. The vehicle 1 may be provided with a plurality of cameras taking pictures in different orientations or having different focal lengths.

Each time an image is generated, the camera 2 outputs the generated image and the generation time of the image to the ECU 3.

The ECU 3 executes a vehicle control process for the vehicle 1. To this end, the ECU 3 includes a communication interface 11, memories 12 and a processor 13. The communication interface 11, the memory 12, and the processor 13 may each be configured as separate circuits or may be integrally configured as a single integrated circuit.

The communication interface 11 includes an interface circuit for connecting the ECU 3 to other devices of the vehicle 1. The communication interface 11 passes the image received from the camera 2 and the generation time thereof to the processor 13.

The memory 12 is an example of a storage unit, and includes, for example, a volatile semiconductor memory and a non-volatile semiconductor memory. The memory 12 stores various types of data used in the vehicle control process executed by the processor 13. For example, the memory 12 stores parameters of the camera 2 such as a focal length, an imaging direction, and an attachment position, and various parameters for specifying a classifier used for detecting a feature. The memory 12 temporarily stores the image received from the camera 2, the generation time thereof, and various data generated during the vehicle control process. Further, the memory 12 may store map information representing the position and range of each road section and the maximum speed for that road section. Note that, unlike the high-precision map, the map information does not need to include information on the shape of each road section.

The processor 13 includes one or more central processing units (CPUs) and a peripheral circuit thereof. The processor 13 may further include another operating circuit such as a logic-arithmetic unit, an arithmetic unit, or a graphics processing unit. Then, the processor 13 executes a vehicle control process for the vehicle 1. Further, the processor 13 stores the image received from the camera 2 and the generation time thereof in the memory 12.

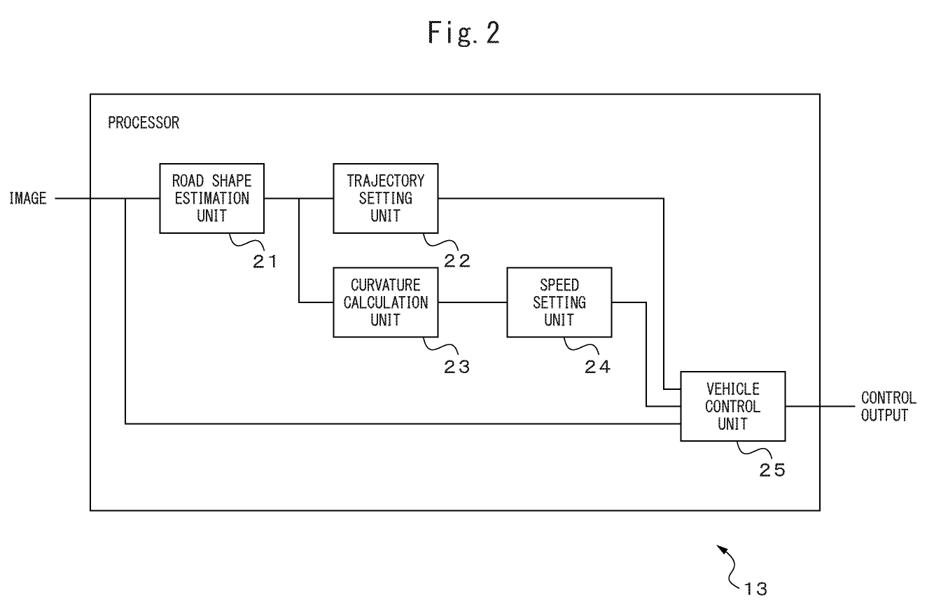

FIG. 2 is a functional block diagram of the processor 13 related to the vehicle control process. The processor 13 includes a road shape estimation unit 21, a trajectory setting unit 22, a curvature calculation unit 23, a speed setting unit 24, and a vehicle control unit 25. Each of these units included in the processor 13 is, for example, a functional module implemented by a computer program executed by the processor 13. Alternatively, each of these units included in the processor 13 may be a dedicated operating circuit provided in the processor 13.

The road shape estimation unit 21 estimates a shape of a road section in which the vehicle 1 will travel in the future based on an image representing the surroundings of the vehicle 1 generated by the camera 2 having a predetermined region in the traveling direction of the vehicle 1 as an imaging range for each predetermined cycle. For this purpose, the road shape estimation unit 21 detects a predetermined feature represented in the latest image by inputting the latest image to a classifier trained in advance so as to detect the predetermined feature provided on the road or around the road. The predetermined feature is a feature provided along the shape of the road, and is, for example, a guardrail, a curb or a road marking on the road surface along the extending direction of the road, such as a lane division line. The classifier may be configured as a convolutional neural network (CNN) for object detection, such as Single Shot MultiBox Detector or YOLO, or a CNN for semantic segmentation, such as U-Net. Alternatively, the classifier may be configured as a deep neural network (DNN) with attention mechanisms, such as Vision Transformer. Alternatively, the classifier may be a classifier based on a mechanical-learning technique other than DNN, such as a support vector machine. The classifier is trained in advance according to a predetermined learning method such as a back propagation using a plurality of teacher images including an image in which any type of feature to be detected is represented.

When a feature is detected, the road shape estimation unit 21 estimates a road shape based on the feature. For this purpose, the road shape estimation unit 21 refers to the parameters of the camera 2 such as the attachment position, the shooting direction, and the angle of view to estimate, for each feature, the position of the feature in the coordinate system in the real space based on the position of the camera 2 by determining the position in the coordinate system corresponding to the pixel in which the feature is represented. The road shape estimation unit 21 then assumes that the set of the positions of the individual features represented by the coordinate system represents the shape of the road on which the vehicle 1 will travel in the future. In particular, in a case where a plurality of lane dividision lines are detected as features, the road shape estimation unit 21 sets the two lane division lines closest to the vehicle 1 as lane division lines that divide the lane in which the vehicle 1 is traveling (hereinafter referred to as “host lane”). Then, the road shape estimation unit 21 estimates the shape represented by the two lane division lines that divide the host lane as the shape of the road on which the vehicle 1 will travel in the future.

Each time the road shape is estimated, the road shape estimation unit 21 passes a set of positions of individual features representing the estimated road shape to the trajectory setting unit 22 and the curvature calculation unit 23.

Each time the shape of the road section is estimated, the trajectory setting unit 22 sets a target trajectory that is a trajectory that is planned to pass when the vehicle 1 travels in the road section based on the estimated road shape. For example, when two lane division lines that divide the host lane are detected and the road shape is represented by the two lane division lines, the trajectory setting unit 22 sets the target trajectory so as to pass through the center of the two lane division lines. Further, when the road section on which the vehicle 1 is traveling is a section where driving on the left is required and a curbstone or a guardrail located on the left side of the vehicle 1 in the traveling direction of the vehicle 1 is detected, and the road shape is represented by the curbstone or the guardrail, the trajectory setting unit 22 sets the target trajectory so as to pass through a position separated from the curbstone or the guardrail toward the center side of the road by a predetermined offset distance. The predetermined offset-distance is set so as to allow a distance of the order of 1m to several meters between the curbstone or the guardrail and the vehicle 1.

Further, the trajectory setting unit 22 may set the target trajectory of the undetected section in which the feature used for estimating the road shape is not detected by executing interpolation according to a predetermined interpolation method so as to smoothly connect the target trajectory set for the preceding and succeeding sections in the undetected section. The predetermined interpolation method may be, for example, spline interpolation.

The trajectory setting unit 22 notifies the vehicle control unit 25 of the set target trajectory.

The curvature calculation unit 23 calculates the curvature of each point of the road section in which the road shape is estimated by averaging the curvature of the point determined based on the shape of the road section estimated from each of the plurality of images obtained in the latest predetermined period.

Each time the road shape is estimated, the curvature calculation unit 23 calculates the curvature at each point of the road section based on the set of the positions of the features representing the road shape. At this time, the curvature calculation unit 23 obtains an approximate curve passing through the position of the feature corresponding to the point of interest and the position of the features in the front and rear sections, and sets the curvature of the approximate curve as the curvature at the point of interest. The curvature calculation unit 23 calculates the curvature of each point by repeating the above-described process while changing the point of interest. When two lane division lines that divide the host lane are detected as representing the estimated road shape, the curvature calculation unit 23 may calculate the curvature for each point on any lane division line. Alternatively, the curvature calculation unit 23 may calculate, for each of the two lane division lines, the curvature at each point on the lane division line.

Further, the curvature calculation unit 23 executes alignment between a plurality of road shapes estimated from a plurality of images generated at different times. For this purpose, the curvature calculation unit 23 estimates the position of the vehicle 1 at the generation time of each image used for estimating the road shape. At this time, the curvature calculation unit 23 obtains, by dead reckoning, the difference in the position and the difference in the traveling direction of the vehicle 1 at the generation time of each past image obtained within a predetermined period with respect to the position and the traveling direction of the vehicle 1 at the generation time of the latest image, based on the sensor signal obtained by a sensor (not shown) for detecting the behavior of the vehicle 1, such as an acceleration sensor or a gyro sensor provided in the vehicle 1. Alternatively, the curvature calculation unit 23 may determine the position of the vehicle 1 at the generation time of each image within a predetermined period by a positioning device (not shown). Similarly, the curvature calculation unit 23 may measure the traveling direction of the vehicle 1 at the generation time of each image within a predetermined period by an orientation sensor (not shown) mounted on the vehicle 1. The curvature calculation unit 23 may determine the difference in the position and the difference in the traveling direction of the vehicle 1 at the generation time of each past image obtained within a predetermined period with respect to the position and the traveling direction of the vehicle 1 at the generation time of the latest image based on the position and the traveling direction of the vehicle 1 at the generation time of each image.

The curvature calculation unit 23 aligns the plurality of road shapes by changing the position and the direction of the road shape estimated from the past images by the difference between the position of the vehicle 1 and the difference between the traveling direction at the generation time of each image with respect to the position and the traveling direction of the vehicle 1 at the generation time of the latest image. Then, the curvature calculation unit 23 averages the curvature of each of the plurality of aligned road shapes at the same point to calculate the curvature of the point. At this time, For a point of interest on the road shape estimated from the latest image, when the point closest to the point of interest on the road shape estimated from a past image after alignment is within a predetermined distance (for example, several tens of centimeters to 1 meter) from the point of interest, the curvature calculation unit 23 may determine the point of interest and the closest point as the same point. Further, the curvature calculation unit 23 may execute weighted averaging on the curvature of the same point in each of the plurality of road shapes by using a weighting coefficient that increases as the image generation time is closer to the current time. Alternatively, the curvature calculation unit 23 may average the curvature of each point at the time of the preceding road shape estimation and the curvature of the corresponding point of the road shape estimated from the latest image by using the forgetting coefficient. As a result, with respect to each point, the distance from the vehicle 1 is relatively close, and the weight becomes larger as the curvature is represented larger on the image, so that the accuracy of estimating the curvature is improved. Alternatively, the curvature calculation unit 23 may execute weighted averaging on the curvature of the same point in each of the plurality of road shapes by using a weighting coefficient that increases as the probability of feature detection increases at the point of interest. The probability of feature detection may be the confidence level of the detected feature for that point output by the classifier.

In a case where the lane division line is detected as representing the road shape, the curvature calculation unit 23 may set the predetermined period at a point where the lane division line is not detected even though it is estimated that the lane division line is originally present in the latest image where the lane division line is detected, to be longer than the predetermined period at a point where the lane division line is detected. As described above, by averaging the curvature over a longer period at the point where the detection of the lane division line fails, even if the point is concealed by another vehicle in the latest image, there is a high possibility that an image obtained at a timing at which the lane division line at the point is not concealed can be referred to. Therefore, the curvature calculation unit 23 can improve the accuracy of estimating the curvature at such a point. Note that, although it is estimated that the lane division line is originally present, a point where the lane division line is not detected may be, for example, a point where the lane division line is determined to be present by interpolation based on the lane division line detected in the front and rear sections, or a place within a predetermined distance from the point.

In addition, with respect to the situation around the vehicle 1, the curvature calculation unit 23 may increase the predetermined period as the number of teacher images used for learning the classifier used for detecting the lane division line is smaller. In this case, for each environment, a period length table representing a length of a predetermined period corresponding to the number of teacher images corresponding to the environment is stored in advance in the memory 12. The curvature calculation unit 23 identifies the environment around the vehicle 1 based on an image obtained by the camera 2 or a sensor signal obtained by a sensor (not shown) for detecting the environment around the vehicle 1 mounted on the vehicle 1. Then, the curvature calculation unit 23 may determine the length of the predetermined period corresponding to the specified environment by referring to the period length table.

The environment around the vehicle 1 is represented by, for example, the weather around the vehicle 1 such as sunny weather and rainy weather, or the brightness around the vehicle 1. For example, when the number of teacher images in the rainy weather is smaller than the number of teacher images in the fine weather, the length of the predetermined period corresponding to the rainy weather is set longer than the length of the predetermined period corresponding to the fine weather in the period length table. In addition, when the number of teacher images in a dark environment such as at night is smaller than the number of teacher images in a bright environment such as during daytime, the length of the predetermined period corresponding to the dark environment is set to be longer than the length of the predetermined period corresponding to the bright environment in the period length table.

When the situation around the vehicle 1 is represented by weather, the curvature calculation unit 23 determines that the weather around the vehicle 1 is rainy when the amount of rain detected by the rain sensor, which is an example of the above-described sensor, is equal to or greater than a predetermined threshold, and determines that the weather around the vehicle 1 is fine weather when the detected amount of rain is less than the predetermined threshold. Then, the curvature calculation unit 23 determines the length of the predetermined period corresponding to the weather around the vehicle 1 by referring to the period length table. In addition, in a case where the situation around the vehicle 1 is represented by brightness, the curvature calculation unit 23 may determine the length of the predetermined period corresponding to the illuminance detected by the illuminance sensor, which is another example of the above-described sensor, by referring to the period length table. Note that the curvature calculation unit 23 may identify the environment around the vehicle 1 by inputting the image generated by the camera 2 to a classifier for identifying the environment around the vehicle 1. Such a classifier may be configured as a CNN or DNN with attention mechanisms.

Similarly, with respect to the road section in which the vehicle 1 is traveling, the curvature calculation unit 23 may increase the predetermined period as the number of teacher images used for training the classifier used for detecting the lane division line is smaller. In this case, for each road section, a period length table representing a length of a predetermined period corresponding to the number of teacher images representing the environment surrounding the road section is stored in advance in the memory 12. Then, the curvature calculation unit 23 identifies a road section in which the vehicle 1 is traveling by referring to the current position of the vehicle 1 determined by a positioning device (not shown) mounted on the vehicle 1 and map information stored in the memory 12. Then, the curvature calculation unit 23 may determine the length of the predetermined period corresponding to the specified road section by referring to the period length table. As described above, the curvature calculation unit 23 averages the curvature over a longer period in an environment in which the training of the classifier is not sufficient, thereby improving the accuracy of estimating the curvature of the road section even under such an environment.

The curvature calculation unit 23 notifies the speed setting unit 24 of the curvature of each point of the road section in which the road shape is estimated.

The speed setting unit 24 sets a target speed at which the vehicle 1 travels in the road section in accordance with the curvature of each point of the road section in which the road shape is estimated. For this purpose, the speed setting unit 24 determines the upper limit speed corresponding to the maximum value of the curvature by referring to a reference table representing the upper limit speed for each curvature based on the maximum value of the curvatures of the individual points. Then, the speed setting unit 24 sets the upper limit speed to the target speed. The reference table may be stored in advance in the memory 12. When the speed set by the driver via the operation device provided in the vehicle interior of the vehicle 1 is lower than the upper limit speed, the speed setting unit 24 may set the speed set by the driver as the target speed. In addition, in a case where the map information indicating the position and the range of each road section and the maximum speed for the road section is stored in the memory 12, the speed setting unit 24 specifies the maximum speed set for the road section including the current position of the vehicle 1. When the specified maximum speed is lower than the upper limit speed corresponding to the maximum value of the curvature, the speed setting unit 24 may set the maximum speed to the target speed. The current position of the vehicle 1 can be the latest position determined by the positioning device.

The speed setting unit 24 may correct the target speed to be newly set so that the difference between the target speed set last time and the target speed to be newly set falls within a predetermined allowable change range so that the vehicle 1 does not perform sudden acceleration/deceleration.

The speed setting unit 24 notifies the vehicle control unit 25 of the set target speed.

The vehicle control unit 25 controls the vehicle 1 so that the vehicle 1 travels along the target trajectory in the road section in which the road shape is estimated at the target speed. For example, the vehicle control unit 25 projects the target trajectory on an image with reference to parameters of the camera 2 such as an attachment position, an imaging direction, and a focal length. Then, the vehicle control unit 25 controls steering so that the amount of deviation between the position of the projected target trajectory and the position of the target trajectory on the image when the vehicle 1 is positioned on the target trajectory (hereinafter, referred to as an ideal position) becomes 0. When the position of the projected target trajectory is located on the left side of the ideal position, the vehicle 1 is traveling on the right side of the target trajectory, and therefore, the vehicle control unit 25 controls the steering so that the traveling direction of the vehicle 1 is leftward of the current traveling direction. When the position of the projected target trajectory is located on the right side of the ideal position, the vehicle control unit 25 controls the steering so that the traveling direction of the vehicle 1 is rightward of the current traveling direction. Incidentally, as the amount of deviation increases, the vehicle control unit 25 may increase the amount of rotation of the steering angle.

Further, the vehicle control unit 25 controls the powertrain and the brake so that the difference between the speed of the vehicle 1 measured by a vehicle speed sensor (not shown) mounted on the vehicle 1 and the target speed becomes 0.

When there is another vehicle traveling in front of the vehicle 1 in the host lane (hereinafter, referred to as a preceding vehicle), the vehicle control unit 25 may control the powertrain and the brake so that the distance between the vehicle 1 and the preceding vehicle is equal to or greater than a predetermined distance. In this case, the vehicle control unit 25 inputs the image generated by the camera 2 to a classifier trained in advance so as to detect another vehicle, thereby detecting the other vehicle represented in the image. Then, the vehicle control unit 25 identifies, as the preceding vehicle, the other vehicle represented in the host lane region sandwiched between the two lane division lines that divide the host lane in the image among the detected other vehicles. Here, the position on the image and the orientation viewed from the camera 2 correspond to one-to-one. Further, it is estimated that the position of the lower end of the region where the preceding vehicle is represented on the image represents the position where the preceding vehicle is in contact with the road surface. Therefore, the vehicle control unit 25 may estimate the distance from the vehicle 1 to the preceding vehicle by referring to the position of the lower end of the region in which the preceding vehicle is represented on the image and the parameters of the camera 2 such as the attachment position, the shooting direction, and the angle of view. When the estimated distance to the preceding vehicle is less than the predetermined distance, the vehicle control unit 25 may control the powertrain and the brake so that the vehicle 1 decelerates. On the other hand, when the estimated distance to the preceding vehicle is equal to or more than the predetermined distance, the vehicle control unit 25 may control the powertrain and the brake so that the speed of the vehicle 1 approaches the target speed.

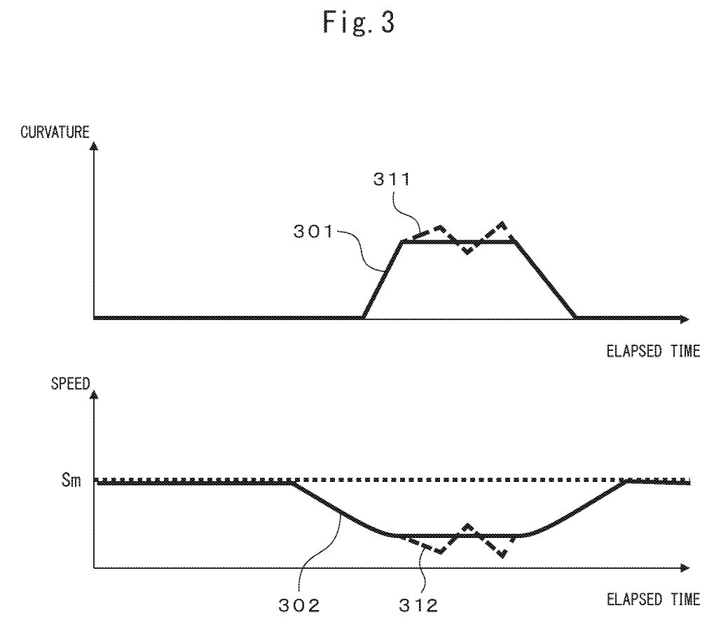

FIG. 3 is a timing chart illustrating a temporal change in curvature and a target speed according to the present embodiment and a temporal change in curvature and a target speed according to a comparative example. In FIG. 3, in the comparative example, each time the road shape is estimated, the curvature itself calculated from the estimated road shape is used for setting the target speed. In FIG. 3, the horizontal axis represents elapsed time. In the upper chart, the vertical axis represents curvature. The graph 301 represents a temporal change in curvature used for setting the target speed according to the present embodiment, and the graph 311 represents a temporal change in curvature used for setting the target speed according to the comparative example. In the lower chart, the vertical axis represents speed. Graph 302 represents a temporal change in the target speed according to the present embodiment, and graph 312 represents a temporal change in the target speed according to the comparative example.

In the comparative example, since the curvature is not averaged, the curvature may suddenly fluctuate at the same point every time the road shape is estimated in the curve section due to the effect of the calculation error of the curvature corresponding to the detection accuracy of the feature used for estimating the road shape. In addition, since the curvature increases in the curve section, the target speed is set to be lower than the speed Sm set by the drivers. In the comparative example, since the curvature abruptly changes every time the road shape is estimated, the target speed to be set also abruptly changes. When the target speed changes rapidly, the vehicle 1 is accelerated or decelerated rapidly when the speed of the vehicle 1 is to follow the target speed, and the behavior of the vehicle 1 becomes unstable, which may cause the occupant of the vehicle 1 to become anxious. On the other hand, in the present embodiment, since the curvature is averaged for each individual point over the latest predetermined period, the temporal change of the curvature used for setting the target speed (that is, the maximum value of the curvature in the road section in which the road shape is estimated) becomes smooth. Therefore, the target speed to be set also changes smoothly, and the behavior of the vehicle 1 is prevented from becoming unstable.

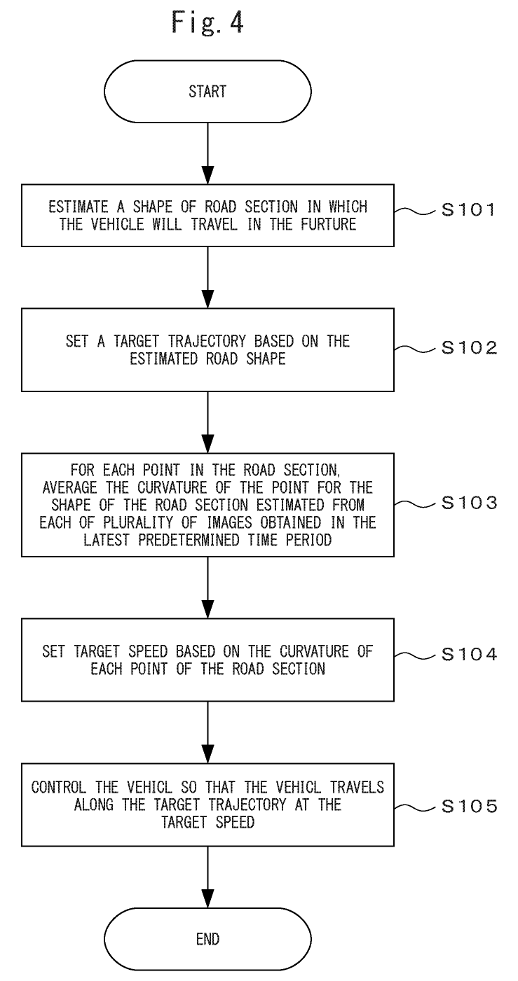

FIG. 4 is an operation flowchart of the vehicle control process. The processor 13 may execute the vehicle control process according to the following operation flowchart.

The road shape estimation unit 21 estimates the shape of the road section in which the vehicle 1 will travel in the future based on the image generated by the camera 2 (step S101). The trajectory setting unit 22 sets a target trajectory based on the estimated road shape (step S102).

The curvature calculation unit 23 calculates, for each point of the road section in which the road shape is estimated, the curvature of the point of the road section by averaging the curvature of the point calculated based on the shape of the road section estimated from each of the plurality of images obtained in the latest predetermined time period (step S103). The speed setting unit 24 sets the target speed based on the curvature of each point of the road section in which the road shape is estimated (step S104).

The vehicle control unit 25 controls the vehicle 1 so that the vehicle 1 travels along the target trajectory at the target speed (step S105). Then, the processor 13 ends the vehicle control process.

As described above, the vehicle control device estimates the shape of the road section in which the vehicle will travel in the future based on the image which represents the situation around the vehicle and is generated by the camera mounted on the vehicle, and sets the target trajectory of the vehicle based on the estimated shape every time the shape of the road section is estimated. As described above, with respect to the setting of the target trajectory, the road shape itself estimated from the individual images is used instead of the road shape averaged between the plurality of images or between the preceding and succeeding sections. Therefore, this prevents the target trajectory from being displaced to the outside of the curve due to the inability of the estimated change in curvature to follow the change in the actual curvature of the road at a point where the curvature changes greatly, such as an approach point to a curve section. As a result, even if the vehicle is caused to travel along the target trajectory, it is prevented that the vehicle is likely to deviate from the road on which the vehicle is traveling. Further, the vehicle control device calculates, for each point of the road section, the curvature of the point of the road section by averaging the curvature of the point calculated based on the shape of the road section estimated from each of the plurality of images obtained in the latest predetermined period, and sets a target speed at which the vehicle travels in the road section in accordance with the curvature of each point of the road section. As a result, a sudden change in curvature due to a change in the estimation result of the road shape caused by the detection accuracy of the feature or the like is suppressed, and therefore, a sudden change in the target speed is also suppressed. Therefore, the vehicle control device can set a target trajectory that does not deviate in the curve section without using a high-precision map including information on the shape of each road section, and can stabilize the behavior of the vehicle.

According to the modification, the road shape estimation unit 21 may estimate, as the shape of the road section, a path on which the vehicle 1 can travel for each lane in the road section in which the vehicle 1 will travel in the future (hereinafter referred to as a travelable path). In this case, the road shape estimation unit 21 obtains the travelable path for each lane by inputting the image generated by the camera 2 to the classifier trained in advance so as to output the travelable path for each lane. Such classifier is configured as a CNN or a DNN with attention mechanisms. The travelable path for each lane is represented by a coordinate system based on the position of the camera 2. In this case, the trajectory setting unit 22 may specify the travelable path closest to the vehicle 1 among the travelable paths for each lane as the travelable path for the host lane, and select the specified travelable path as the target trajectory. Further, the curvature calculation unit 23 may calculate the curvature of each point on the travelable path for the host lane in the same manner as in the above-described embodiment, and average the curvature of the point over a predetermined period.

The computer program for realizing the functions of the processor 13 of the ECU 3 according to the above-described embodiment or modification may be provided in a form recorded on a computer-readable portable recording medium such as a semiconductor memory, a magnetic recording medium, or an optical recording medium.

As described above, a skilled person can make various modifications according to the embodiment within the scope of the present invention.

What is claimed is:

1. A vehicle control device comprising:
a processor configured to:
estimate a shape of a road section in which a vehicle will travel in the future based on an image which represents a periphery of the vehicle and is generated by a camera mounted on the vehicle at every predetermined period,
set a target trajectory of the vehicle based on the estimated shape each time the shape of the road section is estimated,
calculate, for each point of the road section, a curvature of the point of the road section by averaging the curvature of the point calculated based on the shape of the road section estimated from each of a plurality of images obtained in a latest predetermined period,
set a target speed when the vehicle travels in the road section according to the curvature of each point of the road section, and
control the vehicle so that the vehicle travels along the target trajectory in the road section at the target speed.

2. The vehicle control device according to claim 1, wherein the processor is further configured to:
detect a lane division line from the image,
estimate the shape of the road section based on the detected lane division line, and
set the predetermined period at a point at which the lane division line is not detected in the latest image among the individual points of the road section to be longer than the predetermined period at a point at which the lane division line is detected in the latest image.

3. The vehicle control device according to claim 1, wherein the processor is further configured to:
detect the lane division line by inputting the image to a classifier trained in advance so as to detect the lane division line, and
increase the predetermined period as the number of teacher images representing an environment around the vehicle when the vehicle travels in the road section among the plurality of teacher images used for training of the classifier decreases.

4. A vehicle control method comprising:
estimating a shape of a road section in which a vehicle will travel in the future based on an image which represents a periphery of the vehicle and is generated by a camera mounted on the vehicle at every predetermined period;
setting a target trajectory of the vehicle based on the estimated shape each time the shape of the road section is estimated;
calculating, for each point of the road section, a curvature of the point of the road section by averaging the curvature of the point calculated based on the shape of the road section estimated from each of a plurality of images obtained in a latest predetermined period;
setting a target speed when the vehicle travels in the road section according to the curvature of each point of the road section; and
controlling the vehicle so that the vehicle travels along the target trajectory in the road section at the target speed.

5. A non-transitory recording medium that stores a computer program for controlling a vehicle, the computer program causing a processor mounted on the vehicle to execute the process comprising:
estimating a shape of a road section in which a vehicle will travel in the future based on an image which represents a periphery of the vehicle and is generated by a camera mounted on the vehicle at every predetermined period;
setting a target trajectory of the vehicle based on the estimated shape each time the shape of the road section is estimated;
calculating, for each point of the road section, a curvature of the point of the road section by averaging the curvature of the point calculated based on the shape of the road section estimated from each of a plurality of images obtained in a latest predetermined period;
setting a target speed when the vehicle travels in the road section according to the curvature of each point of the road section; and
controlling the vehicle so that the vehicle travels along the target trajectory in the road section at the target speed.
